(19) United States
(12) Patent Application Publication
(10) Pub. No.: US 2014/0304037 A1
(43) Pub. Date: Oct. 9, 2014

(54) METHODS AND SYSTEMS FOR COLLECTING SEGMENTATION DATA

(71) Applicant: Ayub Khan, Cupertino, CA (US)

(72) Inventor: Ayub Khan, Cupertino, CA (US)

(73) Assignee: EBAY INC., SAN JOSE, CA (US)

(21) Appl. No.: 14/102,249

(22) Filed: Dec. 10, 2013

Related U.S. Application Data
(60) Provisional application No. 61/809,792, filed on Apr. 8, 2013.

(51) Int. Cl. G06Q 30/02

(52) U.S. Cl. CPC G06Q 30/0204
USPC 705/7.33

(57) ABSTRACT

A system, method, and computer readable medium are provided to collect and process signal data used to segment a user population. For example, a segmentation client operating on a client machine may be initialized to collect signal data in a signal file maintained by a central repository of a segmentation server. The initialization of the segmentation client may be performed by sending an initialization file to the segmentation client. The initialization file may specify a signal data type of the signal data that is to be collected. Then, an update to the signal file may be received from the segmentation client. The update may include signal data matching the signal data type specified by the initialization file. The user is then grouped in a user segment based on the signal data. Content is then published to the user segment.

### RELATED APPLICATIONS

This application claims the benefit of U.S. Provisional Application No. 61/809,792, filed Apr. 8, 2013, entitled “User Segmentation Using P2P,” which is herein incorporated by reference in its entirety.

### TECHNICAL FIELD

This application relates to data processing. In particular, example embodiments may relate to systems and methods of collecting and processing segmentation data.

### BACKGROUND

For typical computer-implemented applications, segmenting a user population is a challenge. In general, segmentation may be a process of dividing a broad population into subsets or groups based on common needs or attributes. Traditional systems may perform segmentation of a user population based on profile data (e.g., as may be provided when a user registers for a service) submitted by the user. For example, a system may segment registered users by gender, age, occupation, interests, and the like.

Segmenting a user population is useful for targeting content to those users that may be more likely to be receptive or otherwise be interested in that content. By way of example, and not limitation, a system may segment a user population based on an attribute (e.g., gender) that may indicate that a user is more receptive to a product. Based on the segmentation of the user population, the system may then target specific advertisements to the male or female segments, or take some other actions to induce a user to purchase the product or related products.

### BRIEF DESCRIPTION OF THE DRAWINGS

The present invention is illustrated by way of example, and not by way of limitation, in the figures of the accompanying drawings in which:

FIG. 1 is a network diagram depicting a publication system, according to one embodiment, having a client-server architecture configured for exchanging data over a network;

FIG. 2 is an architecture diagram of an example user segmentation system, according to an example embodiment;

FIG. 4 is a block diagram illustrating messages communicated between the segmentation clients and the segmentation server to initialize the segmentation clients, according to an example embodiment;

FIG. 5 is a block diagram illustrating the segmentation clients tracking segmentation signals specified by the initialization data, according to an example embodiment;

FIG. 6 is a block diagram illustrating user segmentation signals being committed to the segmentation server, according to an example embodiment; and

FIG. 7 shows a diagrammatic representation of machine in the example form of a computer system within which a set of instructions may be executed causing the machine to perform any one or more of the methodologies discussed herein.

### DETAILED DESCRIPTION

Although example embodiments have been described with reference to specific examples, it is to be appreciated that various modifications and changes may be made to these embodiments without departing from the broader spirit and scope of the invention. Accordingly, the specification and drawings are to be regarded in an illustrative rather than a restrictive sense.

Example embodiments may provide a generic framework for specifying and capturing segmentation signals detected by a segmentation client. For example, one example embodiment may provide an interface that allows an administrator of an experiment to push an initialization file to a segmentation client operating on a client machine (e.g., a mobile phone). In some cases, the initialization file may specify a type of signal (e.g., location, transaction type, etc.), referred to as a signal data type, that is of interest to the experiment being run by the experiment provider.

After receiving the initialization file, the segmentation client may then begin collecting signal data relating to the signal data type specified by the initialization file. In some cases, collecting the signal data may involve the segmentation client creating a signal file that is maintained by a version control system operating on a segmentation server. A version control system, as used herein, may refer to an application system for managing concurrent user modifications to data (e.g., files). A version control system may manage concurrent user modifications by tracking changes made to a set of files. To help assist in the management of data, many version control systems may provide a number of functional services, such as versioning, locking files, labelling files, creating branches, merging data from different versions of the same file, showing differences of different versions of the same data, and so forth. Well known examples of version control systems include Concurrent Versioning System® (better known as “CVS”) and GIMP®. The signal data relating to the type of segmentation may be stored in the local copy of the signal file maintained by the version control system. The segmentation client may update the local copy of the signal file via a commit command offered by the version control system.

The segmentation client may then update the segmentation system with the signal data by communicating the signal data to the segmentation system. In some cases, the signal data collected by the segmentation client may be communicated to the segmentation server via a push command to the version control system. A push command may communicate the changes to the signal file since the last commit command. That is, the push command synchronizes the local copy of the signal file with the signal file stored by the segmentation server.

In some embodiments, a segmentation system may include multiple segmentation clients implementing the above generic framework, each collecting signal data associated with different users. Accordingly, the segmentation system may then initialize multiple segmentation clients to track specified type of segmentation signals and then receive signal data from those segmentation clients. Upon receiving signal data from multiple segmentation clients, the segmentation system may then segment the population of users operating the segmentation clients. By way of example and not limitation, the segmentation system may group users that have been within a geographical location within a period of time. Such a segmentation of users may be useful for a couponing service, for example, pushing coupons to a group of users that travel to a geographic location associated with a retail store.

It is to be appreciated that example embodiments may find many practical applications. For example, utilizing a generic framework for configuring a segmentation client to track user segmentation data provides a comparatively convenient mechanism for an administrator of an experiment to configure a segmentation client to track a particular type of data in real-time (or substantially real-time) without having the user update additional software or update a version of an application running on the client device. Further, by leveraging a version control system, example embodiments may reduce the data communicated between the segmentation client and the segmentation system. Such is the case because the segmentation client may communicate signal data via a push command. A push command may communicate the changes made between two versions of a file, rather than the whole file itself. Reducing the communication between two computer systems may be important especially where one of the computer systems is a mobile device operating with a limited power source, such as a battery.

These and other embodiments are now described.

### Platform Architecture

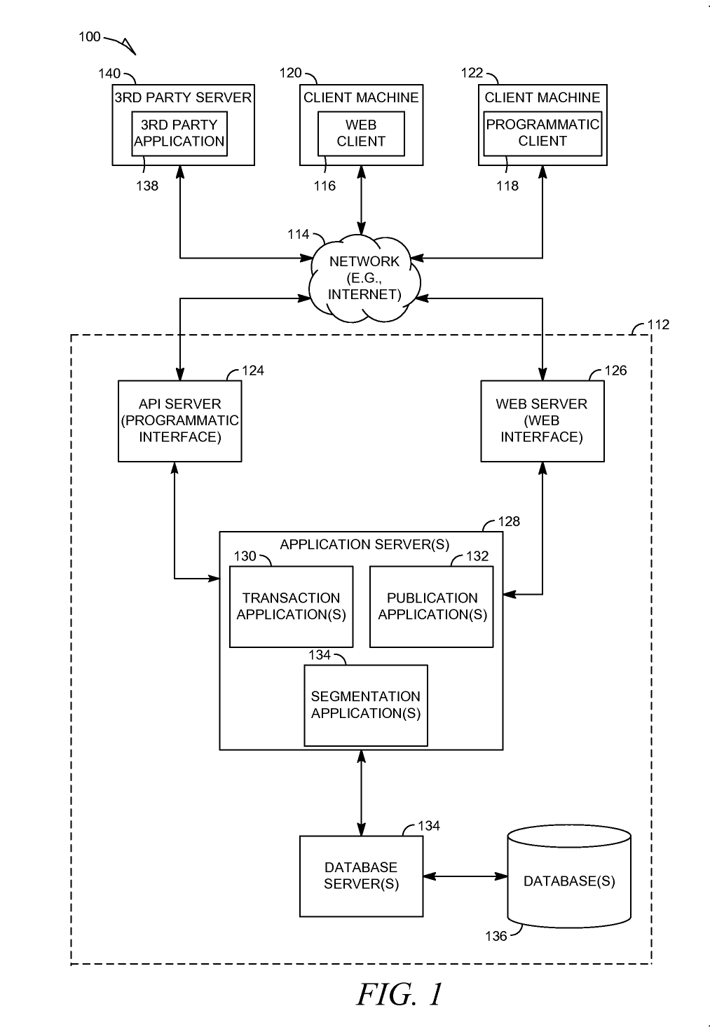

FIG. 1 is a network diagram depicting a publication system 100, according to one embodiment, having a client-server architecture configured for exchanging data over a network. The publication system 100 may be a transaction system where clients, through client machines 120, 122 and a third party server 140, may communicate, view, search, and exchange data with network based publisher 112. For example, the publication system 100 may include various applications for interfacing with client machines and client applications that may be used by users (e.g., buyers and sellers) of the system to publish items for sale in addition to facilitating the purchase and shipment of items.

The network based publisher 112 may provide server-side functionality, via a network 114 (e.g., the Internet) to one or more clients. The one or more clients may include users that utilize the network based publisher 112 as a transaction intermediary to facilitate the exchange of data over the network 114 corresponding to user transactions. User transactions may include receiving and processing item and item related data and user data from a multitude of users, such as payment data, shipping data, item review data, feedback data, etc. A transaction intermediary such as the network based publisher 112 may include one or all of the functions associated with a shipping service broker, payment service and other functions associated with transactions between one or more parties. For simplicity, these functions are discussed as being an integral part of the network based publisher 112, however it is to be appreciated that these functions may be provided by publication systems remotely and/or decoupled from the network based publisher 112.

In various embodiments, the data exchanges within the publication system 100 may be dependent upon user selected functions available through one or more client/user interfaces (UIs). The UIs may be associated with a client machine, such as the client machine 120, utilizing a web client 116. The web client 116 may be in communication with the network based publisher 112 via a web server 126. The UIs may also be associated with a client machine 122 utilizing a client application 118, or a third party server 140 hosting a third party application 138. It can be appreciated in various embodiments the client machine 120, 122 may be associated with a buyer, a seller, payment service provider or shipping service provider, each in communication with the network based publisher 112 and optionally each other. The buyers and sellers may be any one of individuals, merchants, etc.

An application program interface (API) server 124 and a web server 126 provide programmatic and web interfaces to one or more application servers 128. The application servers 128 may host one or more other applications, such as transaction applications 130 and publication applications 132. The application servers 128 may be coupled to one or more data servers 134 that facilitate access to one or more storage devices, such as the data storage 136.

The transaction applications 130 may provide a number of payment processing modules to facilitate processing payment information associated with a buyer purchasing an item from a seller.

The publication applications 132 may include various modules to provide a number of publication functions and services to users that access the network based publisher 112. For example, these services may include, inter alia, formatting and delivering search results to a client.

The segmentation applications 134 may include various modules to provide a number of functions and services related to user segmentation. For example, these services may include, inter alia, initializing a segmentation client to collect signal data of a particular signal data type, aggregating signal data collected by multiple segmentation clients, and running one or more rules on the collected signal data.

FIG. 1 also illustrates an example embodiment of a third party application 138, which may operate on a third party server 140 and have programmatic access to the network based publisher 112 via the programmatic interface provided by the API server 124. For example, the third party application 138 may utilize various types of data communicated with the network based publisher 112 and support one or more features or functions normally performed at the network based publisher 112. For example, the third party application 138 may receive a copy of all or a portion of the data storage 136 that includes buyer shipping data and act as the transaction intermediary between the buyer and seller with respect to functions such as shipping and payment functions. Additionally, in another embodiment, similar to the network based publisher 112, the third party application 138 may also include modules to perform operations pertaining to payment, shipping, etc. In yet another embodiment, the third party server 140 may collaborate with the network based publisher 112 to facilitate transactions between buyers and sellers, such as by sharing data and functionality pertaining to payment and shipping, etc.

As described above, user segmentation may in some cases be a mechanism to sell more on mobile based on user behavior and transaction history. For example, a coupon service may target a number of users based on segmentation such that the coupon communicated is likely to be relevant to the segment. Example embodiments described herein may relate to a mechanism to collect and store user behavior and transaction data, which may form the basis of subsequent user segmentation.

### User Segmentation

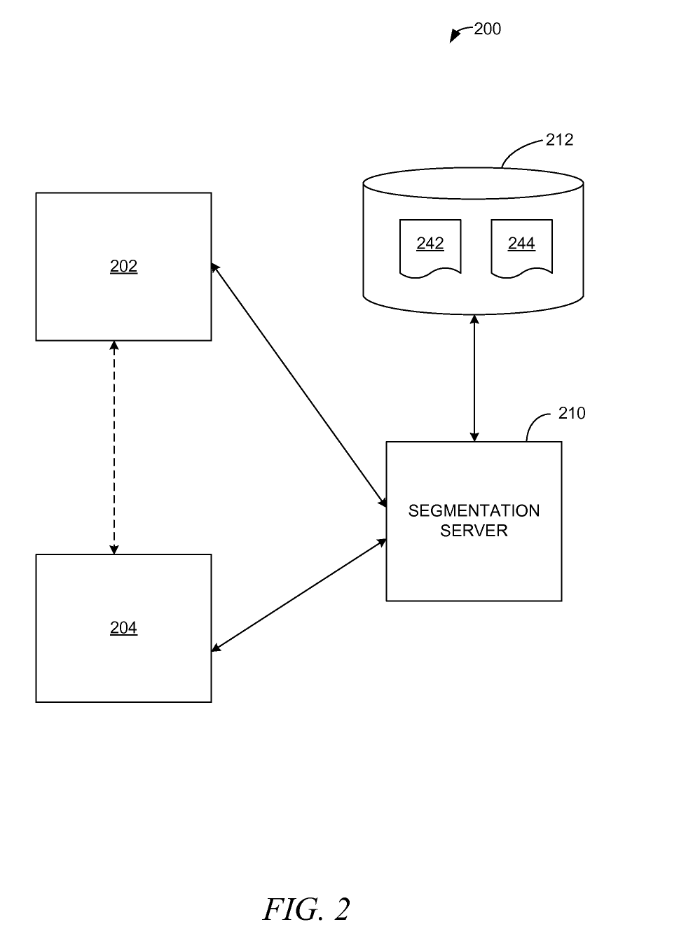

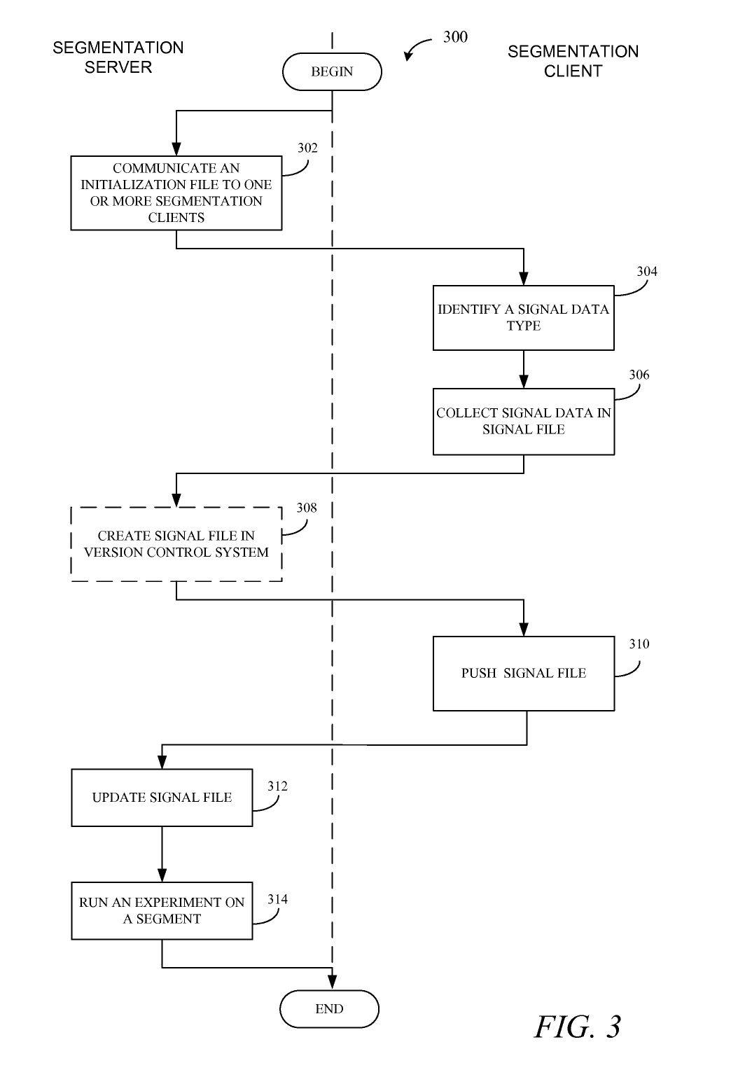

FIG. 2 is an architecture diagram of an example user segmentation system 200, according to an example embodiment. In an example embodiment, portions of the user segmentation system 200 may be deployed within one or more components of the publication system 100 (e.g., the segmentation applications 134 and client machines 120) of FIG. 1.

The user segmentation system 200 may include a segmentation server 210 which is communicatively coupled to segmentation clients 202, 204 and a segmentation database 212 via a network or any other suitable communication medium, such a cellular networks, the Internet, etc. The segmentation clients 202, 204 may execute on different client machines (see, e.g., the client machine 120 of FIG. 1) to collect segmentation signals associated with a user. In particular, as described in greater detail below, the segmentation client may collect signal data, store signal data local to a segmentation client, and then synchronize the locally stored signal data with the segmentation signals stored on the segmentation server 210.

The segmentation server 210 may be a computer-implemented module configured to manage and store the signal data received from the segmentation clients 202, 204. In some embodiments, the segmentation server 210 may be configured to generate user interfaces for creating use cases. A use case may be characterized by initialization data that specifies types of signal data that are to be collected by the segmentation clients 202, 204. The segmentation server 210 may be further configured to communicate the initialization data to the segmentation clients 202, 204 and to the receive signal data back from the segmentation clients 202, 204.

The segmentation database 212 may be a data store configured to store initialization files 242 and signal files 244. As described above, the initialization file 242 may include initialization data that specifies signal types that a segmentation client is to track. The signal files 244 may be data files storing the signal data that the segmentation clients 202, 204 track. In some cases, the initialization files 242 and the signal files 244 are maintained through a version control system. That is, once a segmentation clients 202, 204 are initialized by the segmentation server 210, the segmentation clients 202, 204 store signal data in local files, which is eventually pushed to the segmentation server 210. Thus, in this way, the segmentation server 210 may act as a central repository for the segmentation signals received from the segmentation clients 202, 204.

In some embodiments, the segmentation clients 202, 204 and the segmentation server 210 may communicate with each other via a peer-to-peer protocol that is part of the version control system operated by the segmentation server 210. In this way, the segmentation server 210 may collect and store user segmentation signals independent of the segmentation client, whenever the need may arise. For example, in some cases, the segmentation clients 202 and 206 may be located at geographic locations that are significantly close to each other. In such cases, it may be more efficient to allow the segmentation client 202 to exchange user segmentation signals with the segmentation client 206 rather than with the segmentation server 210, which may be located significantly farther than the segmentation client 206. Further, in some cases, the connection to the segmentation server 210 may be lost, unavailable, or otherwise compromised, thereby resulting in a comparably poor connection between the segmentation client 202 and the segmentation server 210. In such cases, the segmentation client 202 may select to communicate with the segmentation client 204 instead. In an example embodiment, the segmentation clients 202, 204 and the segmentation server 210 each communicate with each other using GIT to provide a peer-to-peer network protocol. GIT is a distributed version control system initially designed and developed by Linus Torvalds for LINUX kernel development. It is, as of the time of this disclosure, free software distributed under the terms of the GNU General Public License version 2.

It should be noted that while in FIG. 2 the segmentation server 210 is depicted as separate from either the segmentation client 202 or segmentation client 204, in some example embodiments the segmentation server 210 may be located on the same physical device as either the segmentation client 202 or segmentation client 204.

FIG. 3 is a flow chart diagram illustrating a method 300 for collecting signal data from one or more segmentation clients, according to an example embodiment. The method 300 may be performed by the segmentation server 210 and any number of the segmentation clients 202, 204 shown in FIG. 2, and, accordingly, is described herein merely by way of reference thereto. However, it will be appreciated that the method 300 may be performed on any suitable hardware.

The method 300 may begin at operation 302 when the segmentation server 210 communicates an initialization file to one or more the segmentation clients. In some embodiments, the initialization file may specify a signal data type that the segmentation client is to collect. For example, the initialization file may specify that geographic locations, transaction amounts, transaction categories (e.g., a category characterizing a good or service purchased), merchant categories, identifiable merchants, time zones, time, transaction frequency, or any other suitable property characterizing user behavior or transaction history may be tracked. According to some embodiments, the initialization file may include additional or alternative information, such as a sample frequency, an experiment identifier, and the like.

Upon obtaining the initialization file, the segmentation client, at operation 304, may parse the contents of the initialization file to identify the signal data type that the segmentation client is to collect or otherwise track.

At operation 306, the segmentation client may then begin collecting signal data matching the signal data type specified by the initialization file. In some cases, collecting the signal data may involve the segmentation client creating a signal file that is maintained by a version control system operated by the segmentation server 210. This is shown as operation 308. As discussed above, a version control system may refer to an application system for managing concurrent user modifications to data (e.g., files). A version control system may manage concurrent user modifications by tracking changes made to a set of files. Well known examples of version control systems include CVS and GIMP®. The signal data collected by the segmentation client may be stored in the local copy of the signal file maintained by the version control system. It should be appreciated that the operation 308 is represented with a dashed line to signify that this operation is optional, at least relative to the operation 306. For example, in some cases, operation 308 may be performed by the segmentation server 210 in conjunction with operation 302. That is, the segmentation server 210 may create the signal file when the initialization file is sent to the segmentation client. In the case the segmentation server 210 creates the signal file, the initialization file may include a filename and file path of the signal file. The segmentation client may use this information to obtain the signal file from the version control system of the segmentation server 210.

At operation 310, the segmentation client may then update the segmentation system by communicating the signal data to the segmentation server 210. In some cases, the signal data may be communicated to the segmentation server 210 via a push command issued to the version control system operated by the segmentation serve 210. A push command may synchronize the copy of the signal file stored locally on the segmentation client with the copy of the signal file stored by the segmentation server 210, as shown in operation 312. In some cases, the push command may communicate the changes to the signal file stored locally by the segmentation client since the last push command, as opposed with sending the contents of the entire signal file.

In some embodiments, the segmentation clients implementing the above generic framework may be operating on additional client machines associated with other users. Accordingly, the segmentation system may then initialize multiple segmentation clients (e.g., operation 302) to collect signal data from these multiple segmentation clients (e.g., operation 312). Upon receiving signal data from the multiple segmentation clients, the segmentation system, at operation 314, may run an experiment involving a segment of the users. The segment may be identified based on similarity of the signal data. By way of example and not limitation, the segmentation system may group users that have been within a geographical location within a period of time. In some cases, running the experiment may involve the pushing content (e.g., an advertisement, coupon, reward, offer, listing, etc.) to the segment.

As discussed above, utilizing a generic framework for configuring a segmentation client to track user segmentation data provides a comparatively convenient mechanism for an administrator of an experiment to configure a segmentation client to track a particular type of data in real-time (or substantially real-time) without having the user update additional software or update a version of an application running on the client device. Further, by leveraging a version control system, example embodiments may reduce the data communicated between the segmentation client and the segmentation system. Such is the case because the segmentation client may communicate tracked data via a commit command. As described above, a commit command may simply communicate the changes to a file, rather than the whole file itself. Reducing the communication between two computer systems may be important especially where one of the computer systems is a mobile device operating with a limited power source, such as a battery.

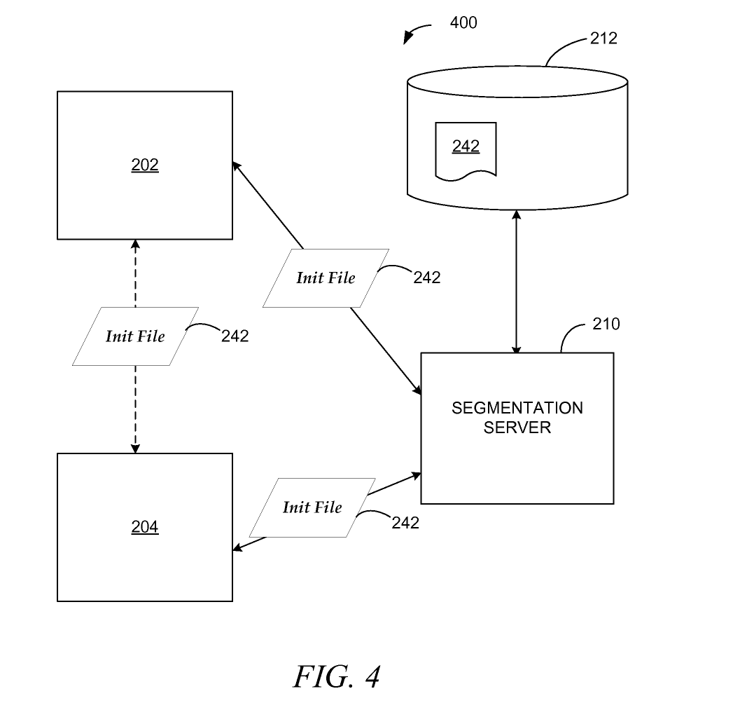

As discussed above, with reference to operation 302 of FIG. 3, the segmentation server 210 may initialize a segmentation client (or segmentation clients) by communicating an initialization file to the segmentation client. An example embodiment for initialize a segmentation client (or segmentation clients) with an initialization file is now described. FIG. 4 is a block diagram illustrating a data flow for communicating initialization files from the segmentation server 210 to the segmentation clients 202, 204, according to an example embodiment. It is to be appreciated that the data flow 400 shown in FIG. 4 may occur before the segmentation server receives signal data from the segmentation clients 202, 204. Thus, in comparison to FIG. 2, the segmentation database 212 does not include signal data 244.

FIG. 4 shows that the segmentation clients 202, 204 may each obtain copies of the initialization file 242 from the segmentation server 210. In an example embodiment, a segmentation client may obtain the initialization file 242 by logging into the repository maintained by the segmentation server 210. Once login completes and is successful, the segmentation client may then initiate a “pull” command according to, for example, the GIT protocol.

As discussed above, in an example embodiment, the initialization file may include signal data types that specify a type of signal data that is to be collected, tracked, recorded, or otherwise obtained by the segmentation clients 202, 204. For example, in some cases, the initialization file 242 may include data or logic that specifies that location data is to be tracked by segmentation clients 202, 204. In some cases, the initialization file 242 may also include data that specifies a frequency in which the segmentation client is to update the segmentation server 210 with segmentation signals detected by the segmentation client. Thus, the initialization data may specify to the segmentation client what data is to be collected and how to collect the data.

As discussed above, some embodiments may utilize a peer-to-peer protocol (e.g., as may be provided by GIT) to communicate data between the various components of the user segmentation system. Accordingly, in some cases, a segmentation client may acquire initialization data from another segmentation client, rather than from the user segmentation system 210. This is shown as a dotted line where the initialization file 242 is communicated between the segmentation clients 202, 204.

Once one or more of the segmentation clients 202, 204 obtain the initialization data, the segmentation clients 202, 204 may begin collecting the signal data specified by the initialization file 242. For example, based on the initialization file 242 specifying location, the segmentation clients 202, 204 may begin collecting the location of the segmentation client (e.g., using a global positioning system (GPS) module in the client machine). Other examples of signal data include transaction amounts, transaction categories (e.g., a category characterizing a good or service purchased), merchant categories, identifiable merchants, time zones, time, transaction frequency, or any other suitable property characterizing user behavior or transaction history.

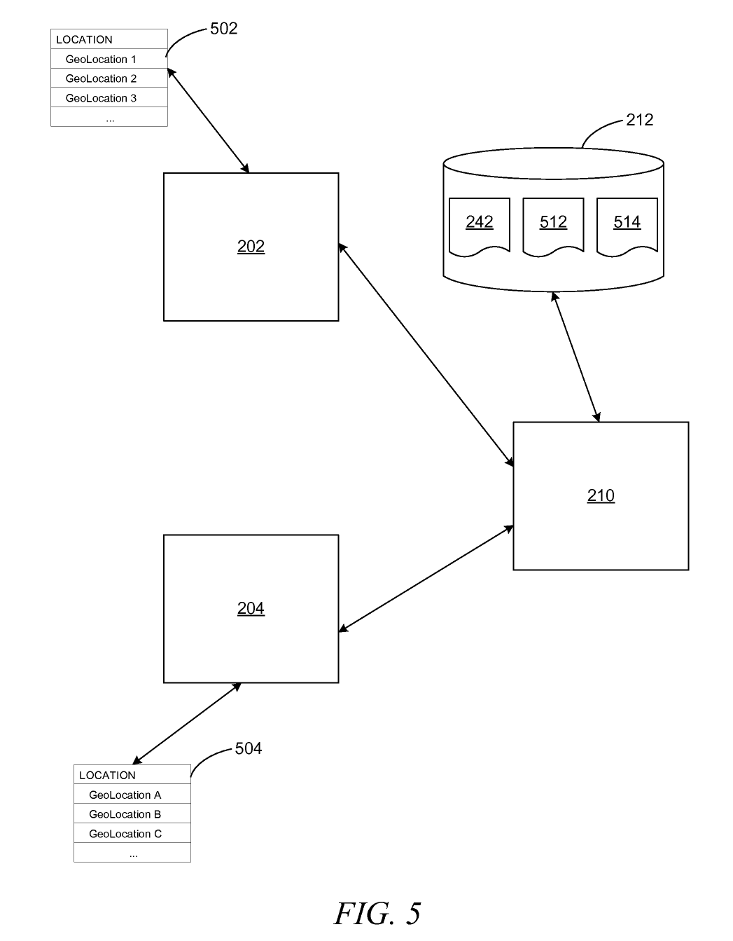

FIG. 5 is a block diagram illustrating the segmentation clients 202, 204 collecting signal data based on the initialization file 422, according to an example embodiment. For example, FIG. 5 shows that the segmentation client 202 has recorded three different locations for the user of the segmentation client 202 in a signal file 502, while the segmentation client 204 has recorded another three locations for the user of the segmentation client 204 in a segmentation file 504. As discussed above, the signal files 502, 504 may be files maintained by a version control system operated by the segmentation server 210. Thus, the signal file 502 may have a corresponding signal file 512 stored in the segmentation database 212. Likewise, the signal file 504 may have a corresponding signal file 514 stored in the segmentation database 212. It is to be appreciated that the signal files 512, 514 are versions of the signal files 502, 504, respectively. The contents of the signal files 512, 514 may, in some cases, not include all the data stored in the signal files 502, 504. This may be the case because the segmentation clients 202, 204 may work on the local copies by storing signal data in their local copies (e.g., signal files 502, 504) and, then, after some time, the segmentation clients 202, 204 may push the signal files 502, 504 to the segmentation database 212 using a protocol associated with the version control system (e.g., using GIT). In this way, the signal file 502 may be viewed as a revision or later version of the signal file 512. The same can be said with regard to signal file 502 being a later version of the signal file 512.

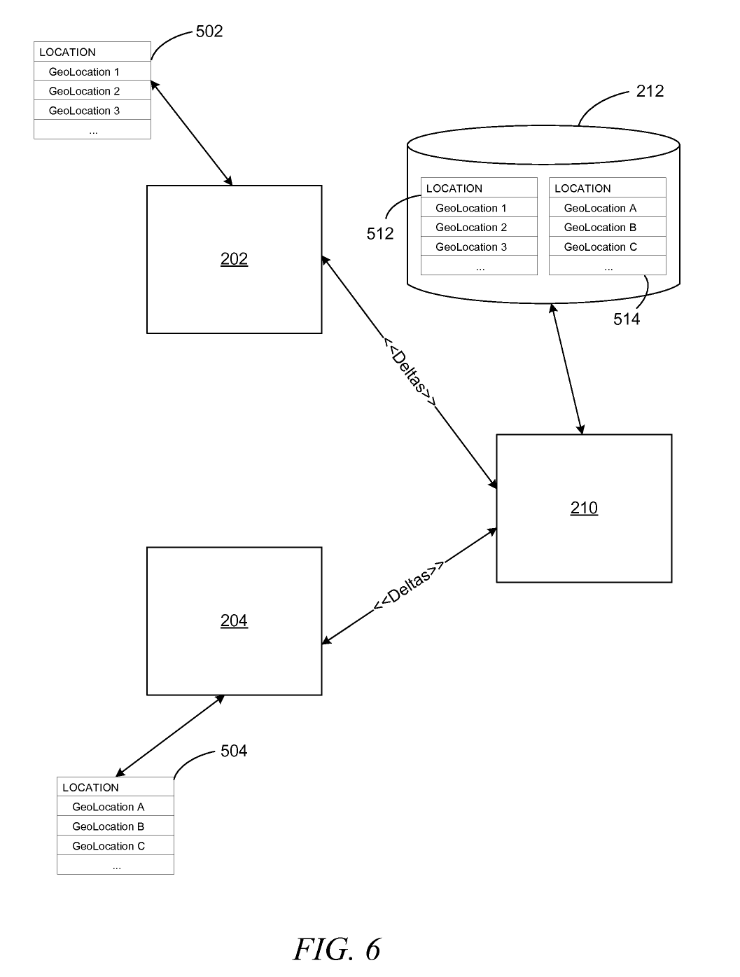

FIG. 6 is a block diagram illustrating segmentation clients 202, 204 pushing signal data to the segmentation server 210, according to an example embodiment. For example, FIG. 6 shows that the segmentation client 202 may push the signal file (e.g., geographical locations) previously committed (e.g., see FIG. 5) to a local repository of the segmentation client 202 to the central repository maintained by the segmentation server 210. Pushing the signal file may refer to an action performed by a segmentation client to synchronize the version of a signal file stored in the local repository to the central repository maintained by the segmentation server 112. In some embodiments, the push command may be communicated according to the GIT protocol.

When the segmentation client 202 pushes the signal file 502 to the segmentation repository 212, some embodiments of the segmentation client 202 may push the signal file 502 by communicating changes between the signal file 502 and the signal file 512, rather than a complete transfer of the signal file 502. By way of example, as previously shown in FIG. 5, the signal file 512 stored in the segmentation repository 212 may have been empty. Accordingly, the push command would communicate data indicating that geographic locations 1-3 should be added to the signal file 512. If the segmentation client 202 then commits geographic locations 4 and geographic location 5 after this push command, a subsequent push would cause the segmentation client 202 to communicate geographic location 4 and geographic location 5 to the signal file 502, rather than geographic locations 1-5. In this way, the overhead of communication user segmentation signals comparatively lower than repeatedly committing the signal file 502.

As FIG. 6 shows, the segmentation client 204 also pushes the signal file 504 in the same manner as the segmentation client 202. However, the signal file 504 may be stored in the signal file 514 stored in the central repository.

Once the segmentation server 210 has stored the segmentation signals from the users or segmentation clients, the segmentation server 210 may then run one or more experiments. An experiment may be logic or data that operates to segment one or more users based on common or similar values of the segmentation signals and then performs a processing action applied to users belonging to a particular segment. By way of example and not limitation, the segmentation server 210 may create a user segment based on those users having been within a particular geographic location (e.g., San Francisco) within a determinable time period (e.g., the last week). Based on the users belonging to the segment, the segmentation server 210 may then send a coupon to those members of that segment.

### Exemplary Computer Systems

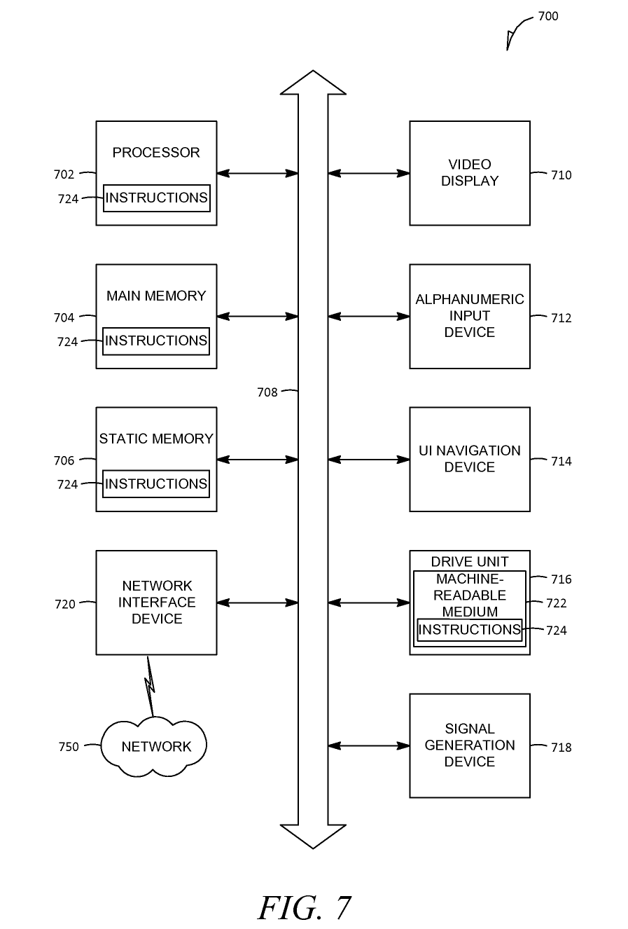

FIG. 7 shows a diagrammatic representation of machine in the example form of a computer system 700 within which a set of instructions may be executed causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU) or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard), a user interface (UI) navigation device 714 (e.g., a mouse), a disk drive unit 716, a signal generation device 718 (e.g., a speaker) and a network interface device 720.

The disk drive unit 716 includes a machine-readable medium 722 on which is stored one or more sets of instructions and data structures (e.g., software 724) embodying or utilized by any one or more of the methodologies or functions described herein. The software 724 may also reside, completely or at least partially, within the main memory 704 and/or within the processor 702 during execution thereof by the computer system 700, the main memory 704 and the processor 702 also constituting machine-readable media.

The software 724 may further be transmitted or received over a network 726 via the network interface device 720 utilizing any one of a number of well-known transfer protocols (e.g., HTTP).

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in example embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Furthermore, the following claims are hereby incorporated into the Detailed Description, with each claim standing on its own as a separate embodiment.

What is claimed is:

1. A computer-implemented system comprising:
a segmentation server implemented by at least one processor and configured to:
initialize a segmentation client operating on a client machine to collect signal data in a signal file maintained by a central repository of a segmentation server, the initializing comprising sending an initialization file to the segmentation client that specifies a signal data type of the signal data;
receive an update to the signal file from the segmentation client, the update including signal data matching the signal data type specified by the initialization file;
group the user in a user segment based on the signal data; and
publish content to the user segment.

2. The system of claim 1, wherein receiving the update to the signal file includes receiving a push command to a version control system executing on the segmentation server, the push command being a request to synchronize a version of the signal file stored by a local repository of the segmentation client with a version of the signal file stored by a central repository of the segmentation server.

3. The system of claim 1, wherein the update to the signal file represents changes to the signal file since a previous update to the signal file was received.

4. The system of claim 1, wherein initializing the segmentation client includes responding to a pull command to a version control system operated by a segmentation server, the pull command creating a version of the initialization file in a local repository operated by the segmentation client.

5. The system of claim 1, wherein initializing the segmentation client includes responding to a pull command to a version control system operated by a segmentation server, the pull command creating a version of the initialization file in a local repository operated by the segmentation client.

6. The system of claim 1, wherein the segmentation client and the segmentation server operate a distributed version control system, the distributed version control system including a local repository maintained by the segmentation client and a central repository maintained by the segmentation server, the local repository maintaining a first version of the signal file, the central repository maintained a second version of the signal file.

7. The system of claim 1, wherein the initialization file includes a file identifier of the signal file.

8. A method comprising:
initializing a segmentation client operating on a client machine to collect signal data in a signal file maintained by a central repository of a segmentation server, the initializing comprising sending an initialization file to the segmentation client that specifies a signal data type of the signal data;
receiving, by one or more processors, an update to the signal file from the segmentation client, the update including signal data matching the signal data type specified by the initialization file;
grouping the user in a user segment based on the signal data; and
publishing content to the user segment.

9. The method of claim 8, wherein receiving the update to the signal file includes receiving a push command to a version control system executing on the segmentation server, the push command being a request to synchronize a version of the signal file stored by a local repository of the segmentation client with a version of the signal file stored by a central repository of the segmentation server.

10. The method of claim 8, wherein the update to the signal file represents changes to the signal file since a previous update to the signal file was received.

11. The method of claim 8, wherein initializing the segmentation client includes responding to a pull command to a version control system operated by a segmentation server, the pull command creating a version of the initialization file in a local repository operated by the segmentation client.

12. The method of claim 8, wherein initializing the segmentation client includes responding to a pull command to a version control system operated by a segmentation server, the pull command creating a version of the initialization file in a local repository operated by the segmentation client.

13. The method of claim 8, wherein the segmentation client and the segmentation server operate a distributed version control system, the distributed version control system including a local repository maintained by the segmentation client and a central repository maintained by the segmentation server, the local repository maintaining a first version of the signal file, the central repository maintained a second version of the signal file.

14. The method of claim 8, wherein the initialization file includes a file identifier of the signal file.

15. A non-transitory computer-readable medium storing executable instructions thereon, which, when executed by a processor, cause the processor to perform operations comprising:
initializing a segmentation client operating on a client machine to collect signal data in a signal file maintained by a central repository of a segmentation server, the initializing comprising sending an initialization file to the segmentation client that specifies a signal data type of the signal data;
receiving, by one or more processors, an update to the signal file from the segmentation client, the update including signal data matching the signal data type specified by the initialization file;
grouping the user in a user segment based on the signal data; and
publishing content to the user segment.

16. The computer-readable medium of claim 15, wherein the operations further comprise receiving the update to the signal file includes receiving a push command to a version control system executing on the segmentation server, the push command being a request to synchronize a version of the signal file stored by a local repository of the segmentation client with a version of the signal file stored by a central repository of the segmentation server.

17. The computer-readable medium of claim 15, wherein the update to the signal file represents changes to the signal file since a previous update to the signal file was received.

18. The computer-readable medium of claim 15, wherein initializing the segmentation client includes responding to a pull command to a version control system operated by a segmentation server, the pull command creating a version of the initialization file in a local repository operated by the segmentation client.

19. The computer-readable medium of claim 15, wherein initializing the segmentation client includes responding to a pull command to a version control system operated by a segmentation server, the pull command creating a version of the initialization file in a local repository operated by the segmentation client.

20. The computer-readable medium of claim 15, wherein the segmentation client and the segmentation server operate a distributed version control system, the distributed version control system including a local repository maintained by the segmentation client and a central repository maintained by the segmentation server, the local repository maintaining a first version of the signal file, the central repository maintained a second version of the signal file.
